(19) United States
(12) Patent Application Publication
(10) Pub. No.: US 2014/0149561 A1
(43) Pub. Date: May 29, 2014

(54) INTEGRATION FRAMEWORK SYSTEM AND METHOD OF PROVIDING INTEGRATION FRAMEWORK

(71) Applicant: Electronics and Telecommunications Research Institute, Daejeon (KR)

(72) Inventors: Myung Nam BAE, Daejeon (KR); Hyochan BANG, Daejeon (KR); In Hwan LEE, Daejeon (KR)

(21) Appl. No.: 13/946,448

(22) Filed: Jul. 19, 2013

(30) Foreign Application Priority Data
Nov. 26, 2012 (KR) 10-2012-0134565

(51) Int. Cl. H04L 12/24

(52) U.S. Cl. CPC H04L 41/0813
USPC 709/221

(57) ABSTRACT

An integration framework system includes an interpreter configured to provide a general-purpose description and interpretation of a resource, a method, and a parameter regarding a hardware device on a network of things. An integration framework system includes an implementation binder configured to provide dynamic binding or dynamic unbinding depending on the change in the resource of the hardware devices.

### RELATED APPLICATIONS

This application claims the benefit of Korean Patent Application No. 10-2012-0134565, filed on Nov. 26, 2012, which is hereby incorporated by reference as if fully set forth herein.

### FIELD OF THE PRESENT INVENTION

The present invention relates to an integration framework which supports REST (REpresentational State Transfer) style thing representations, control, inter-application object communication, service construction, and interconnection system construction. More particularly, the present invention relates to a method of providing various kinds of descriptive language processing to a system, a method of providing dynamic binding/unbinding for implementation under the operation of a system, and a method of configuring and operating resources, methods, and representations for supporting REST-based system construction and dynamic reconfiguration.

### BACKGROUND OF THE PRESENT INVENTION

As technologies which enable communication between all visible things and people in a broader sense than communication between communication equipments or equipments and people, IoT (Internet of Things), WoT (Web of Things), and the like have been suggested.

In regard to the things, sensing, communication, and service technologies need be existed. Accordingly, information regarding all things can be collected and constructed through the Internet, and various services can be provided using the collected and constructed information. In REST which is a representative Web service architecture, a REST application is made to search for a resource and to apply only four methods (CRUD (Create, Read, Update, Delete) style service) to the searched resource, thereby accomplishing the objective. This is, a REST style uses a system in which a resource-oriented Web service is constructed using HTTP, and a service is requested and provided through the resource.

However, a REST-style system does not take into consideration an automated configuration according to the constraints to various hardware devices (including an energy-critical compact sensor node and a large-volume network server device) on a M2M (Machine to Machine) or IoT network, and there is a problem in that Web service configuration and distribution is not easily made.

A REST style service in a wireless sensor network should provide expansion and reduction of a general-purpose Web service description language (for example, Web application description language (WADL)), dynamic binding for software implementation, and dynamic unbinding for unwanted software implementation so as to construct an open structure to be developed, constructed, searched, and used by many individual developers. Meanwhile, in the present situation, the REST assumes higher-level devices than a general-purpose computer, and these functions are not supported.

### SUMMARY OF THE PRESENT INVENTION

In view of the above, the present invention provides a REST style integration framework, capable of ensuring a variety of hardware venders of additional devices, such as sensor nodes, gateways, and network equipments, and software implementation, providing a free remote control on a system and applications, and supporting dynamic reconfiguration according to limited hardware performance.

According to the present invention, a REST style service included in various sensor nodes, user terminals, or servers in an environment, such as M2M (Machine to Machine), IoT (Internet of Things), or WoT (Web of Things), is constructed. Accordingly, it is possible to recognize a request between services mounted in respective devices (execution of a resource and a method), to generate a resource through interpretation of Web service description in response to the request, to permit binding of a relevant method at the time of the request, and to reconfigure an unwanted resource and a relevant method in response to the request. Therefore, it is possible to construct a single REST style system which can be reconfigured and applied depending on the constraints of the target device.

In accordance with an aspect of an exemplary embodiment of the present invention, there is provided an integration framework system, which includes: an interpreter configured to provide a general-purpose description and interpretation of a resource, a method, and a parameter regarding a hardware device on a network of things; and an implementation binder configured to provide dynamic binding or dynamic unbinding depending on the change in the resource of the hardware devices.

In the exemplary embodiment, wherein the network of things is based on a representation state transfer (REST) style.

In the exemplary embodiment, wherein the implementation binder provides dynamic binding or dynamic unbinding of a resource of an application service.

In the exemplary embodiment, wherein the implementation binder provides dynamic binding or dynamic unbinding of a resource of a system service.

In the exemplary embodiment, wherein the integration framework system supports a dynamic reconfiguration depending on a remote control and hardware constrained performance of a system resource and an application resource.

In accordance with another aspect of an exemplary embodiment of the present invention, there is provided a method of providing an integration framework for an integration framework system, which includes: processing a description language regarding a hardware device on a network of things; providing dynamic binding or dynamic unbinding regarding implementation while a system is operating; and providing a resource, a method, and representation for dynamic reconfiguration of the hardware device.

In the exemplary embodiment, wherein said processing a description language comprises: defining a resource; defining a usable method through the resource; and adding definition regarding a parameter to the method.

In the exemplary embodiment, wherein the network of things is based on a REST style.

In the exemplary embodiment, wherein said providing dynamic binding or dynamic unbinding comprises: providing dynamic binding or dynamic unbinding of a resource regarding an application service.

In the exemplary embodiment, wherein said providing dynamic binding or dynamic unbinding comprises: providing dynamic binding or dynamic unbinding of a resource regarding a system service.

In the exemplary embodiment, wherein said providing dynamic binding or dynamic unbinding comprising: supporting a dynamic reconfiguration depending on a remote control and hardware constrained performance of a system resource and an application resource.

### BRIEF DESCRIPTION OF THE DRAWINGS

The above and other objects and features of the present invention will become apparent from the following description of the embodiments given in conjunction with the accompanying drawings, in which:

FIG. 1 is an exemplary network diagram to which an integration framework in accordance with an embodiment of the present invention is applied;

FIG. 2 is a block diagram of an integration framework system in accordance with an embodiment of the present invention;

FIG. 3 is a diagram specifically showing an integration framework in accordance with an embodiment of the present invention;

FIG. 4 is a diagram showing a REST interface configuration of an integration framework in accordance with an embodiment of the present invention;

FIG. 5 is a flowchart illustrating a procedure of constructing an integration framework service in accordance with an embodiment of the present invention;

FIG. 6 is a flowchart illustrating an initial operation procedure when the integration framework of an embodiment of the present invention is mounted;

FIG. 7 is a flowchart illustrating a procedure of interpreting and processing an HTTP request in accordance with an embodiment of the present invention;

FIG. 8 is a flowchart illustrating a case where an interpreter is further provided in an integrated framework when reconfiguring a system resource in accordance with the flowchart of FIG. 7; and

FIG. 9 is a flowchart illustrating a procedure of unbinding a resource when reconfiguring a system resource in accordance with the flowchart of FIG. 7.

### DETAILED DESCRIPTION OF THE EMBODIMENTS

The advantages and features of exemplary embodiments of the present invention and methods of accomplishing them will be clearly understood from the following description of the embodiments taken in conjunction with the accompanying drawings. However, the present invention is not limited to those embodiments and may be implemented in various forms. It should be noted that the embodiments are provided to make a full disclosure and also to allow those skilled in the art to know the full scope of the present invention. Therefore, the present invention will be defined only by the scope of the appended claims.

In the following description, well-known functions or constitutions will not be described in detail if they would unnecessarily obscure the embodiments of the invention. Further, the terminologies to be described below are defined in consideration of functions in the invention and may vary depending on a user's or operator's intention or practice. Accordingly, the definition may be made on a basis of the content throughout the specification.

The combinations of the each block of the block diagram and each operation of the flow chart may be performed by computer program instructions. Because the computer program instructions may be loaded on a general purpose computer, a special purpose computer, or a processor of programmable data processing equipment, the instructions performed through the computer or the processor of the programmable data processing equipment may generate the means performing functions described in the each block of the block diagram and each operation of the flow chart. Because the computer program instructions may be stored in a computer usable memory or computer readable memory which is capable of intending to a computer or other programmable data processing equipment in order to embody a function in a specific way, the instructions stored in the computer usable memory or computer readable memory may produce a manufactured item involving the instruction means performing functions described in the each block of the block diagram and each operation of the flow chart. Because the computer program instructions may be loaded on the computer or other programmable data processing equipment, the instructions performed by the computer or programmable data processing equipment may provide the operations for executing the functions described in the each block of the block diagram and each operation of the flow chart by a series of functional operations being performed on the computer or programmable data processing equipment, thereby a process executed by a computer being generated.

Moreover, the respective blocks or the respective sequences may indicate modules, segments, or some of codes including at least one executable instruction for executing a specific logical function(s). In several alternative embodiments, it is noticed that the functions described in the blocks or the sequences may run out of order. For example, two successive blocks and sequences may be substantially executed simultaneously or often in reverse order according to corresponding functions.

In order to satisfy various constraints (hardware or software constraints) which are not decided by an objective system in advance, it is necessary to dynamically construct an application resource/service and also to dynamically construct a system resource/service which operates the application resource/service. As the Web provides various media (hypermedia), it is necessary to permit the generalized description of resource/method/parameter for constructing a representational state transfer (REST) based service and the interpretation thereof. It is also necessary to provide a continuous operational service without rebooting the system with the addition of services due to the addition of sensors or the likes.

The present invention includes additional implementation for reconfiguration on an application and a system service requiring dynamic construction, provides an interpreter as a system resource/service, and provides dynamic binding or unbinding of a new service to a changed resource. From this technical spirit, the object of the present invention will be easily attained.

Hereinafter, an embodiment of the present invention will be described in detail with reference to the accompanying drawings.

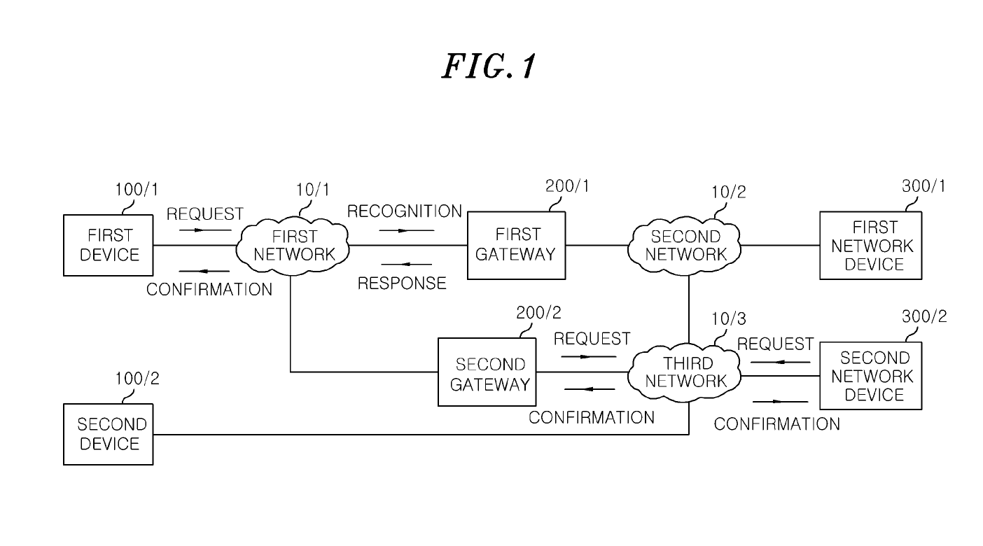

FIG. 1 is an exemplary network diagram to which an integration framework in accordance with an embodiment of the present invention will be described. FIG. 1 shows a REST (REpresentational State Transfer) based integration framework operation environment.

As shown in FIG. 1, the operating environment for a REST style integration framework is a service environment for various hardware devices in the Machine to Machine (M2M) environment or the Internet of Thing (IoT) environment, and includes a first device 100/1, a second device 100/2, a first gateway 200/1, a second gateway 200/2, a first network device 300/1, and a second network device 300/2. The respective devices may be connected together through networks 10/1 to 10/3.

Although in FIG. 1, a given number of devices are shown, it is obvious to those skilled in the art that this is just an illustration for convenience of description, and the number of hardware devices which are connected together through networks is not particularly limited.

In FIG. 1, the devices 100/1 and 100/2 include sensor nodes, and have a sensing function and a transmission function.

The gateways 200/1 and 200/2 play a role of collecting sensing data from the devices 100/1 and 100/2, and the network devices 300/1 and 300/2 have applications mounted thereon.

The devices 100/1, 100/2, 200/1, 200/2, 300/1, and 300/2 have HTTP (or CoAP (Constrained Application Protocol)) mounted thereon. Message exchange regarding to an HTTP request and response is basically made through the networks 10/1 to 10/3.

A service search and execution operation between the first device 100/1 and the gateway 200/1 is requested by an HTTP request message of the transmission-side first device 100/1 on the network 10/1, and after the request is recognized by the reception-side first gateway 200/1, an HTTP response message is transmitted to the first network 10/1.

The first device 100/1 makes confirmation of the HTTP response, and thus the transmission/reception is completed.

Each device includes an integration framework and a device constrained individual implementation, thereby executing REST style service search.

For example, while the first device 100/1 constructs a Web service through individual implementation associated with the integration framework, the second device 100/2 constructs a Web service only through individual implementation with no integration framework. That is, as will be described below, the first device 100/1 includes an interpreter, an implementation binder, a reconfiguration service implementation template, and the like, and the second device 100/2 has only the minimum specification of Web service linkage function and does not provide functions of service construction, reconfiguration, and the like during operation.

The constituent elements of the integration framework may be partially attached and detached in accordance with the change in the specification or objective of the device after installation, and a service in an implementation system is partially attached and detected. That is, the first network device 300/1 and the second network device 300/2 have the same setting initially, and the integration framework may be reconfigured to different system shapes in accordance with a configuration change request during operation.

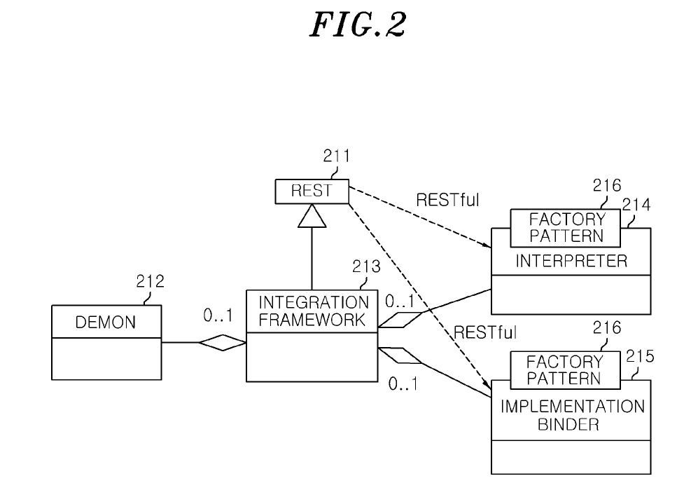

FIG. 2 shows the structure of the integration framework system in accordance with an embodiment of the present invention. The integration framework system includes a default HTTP demon 212, an integration framework 213, an interpreter 214, and an implementation binder 215, which are based on a REST architecture 211. The integration framework system of FIG. 2 is incorporated in any device of FIG. 1, for example, one of the first device 100/1, the first gateway 200/1, and the first network device 300/1.

As shown in FIG. 2, the interpreter 214 and the implementation binder 215 may be selectively applied at the early stage of the system as necessary, or may be dynamically reconfigured like different application services.

The interpreter 214 and the implementation binder 215 include factory patterns 216. Multiple interpreters and different systems of implementation binders may be added to the interpreter 214 and the implementation binder 215 via the factory patterns 216.

The HTTP demon 212 is required only in an integration framework in which it serves as a provider during communication, and is replaced with a client proxy in the case where it serves as a consumer. In the case of a client Web browser, no integration framework is included, and the Web browser may request a service only using a searched resource hierarchy structure and a method resource.

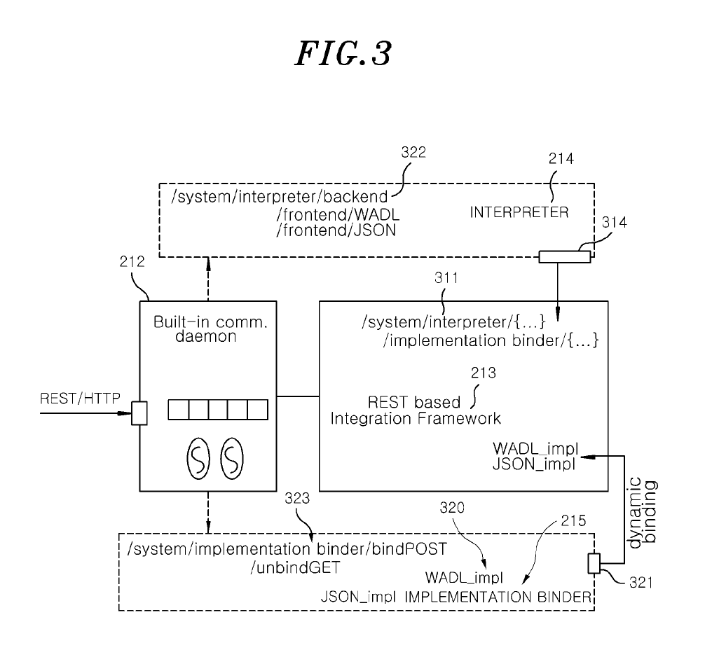

FIG. 3 is a diagram showing a case where an integration framework is embodied in a specific device.

The integration framework 213 includes the interpreter 214 and the implementation binder 215 inside a resource 311 to be provided by the REST. All interpreters 214 which can be provided in the integration framework 213 are provided as a lower-level resource 322 of a “/system/interpreter/” resource in a resource hierarchy structure 311. In FIG. 3, two interpreters are illustrated, which can analyze Web application description language (WADL) description and Java script object notation (JSON) description as an HTTP hypertext type of a user. These interpreter may be constructed with a backend default interpreter which is reflected in the integration framework 213 through resources as interpretation results, methods, and a parameter translation interface (hereinafter, simply referred to as “interface”) 314.

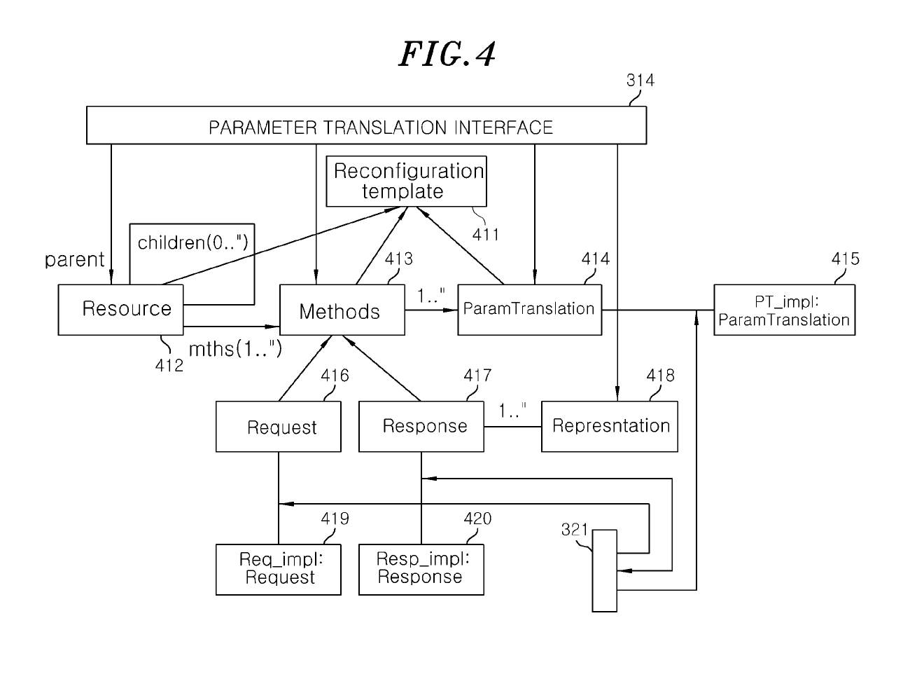

The implementation binder 215 dynamically binds implementations 320 including executable objects to the resources, methods, and parameter translation to be presented to the integration framework by the interface 314 (this will be described in FIG. 4). At this time, the service of the implementation binder 215 to be used is defined as a lower-level resource 323 of a “/system/implementation binder/” resource in accordance with the REST. As a representative example, FIG. 3 illustrates a bindPOST resource which binds a POST method to a specific resource and an unbindGET resource which unbinds a GET method.

FIG. 4 shows the configuration of a REST interface of the integration framework 213.

The integration framework in accordance with the embodiment of the present invention supports the REST, a REST resource 412 is defined in a hierarchy structure (for example, reference numerals 322 and 323 of FIG. 3), and an applicable Method 413 is also defined.

The Method 413 has a Request Method 416 which needs be performed in response to a client's request and a Response Method 417 which is performed for a response including the processing result. Here, a Representation 418 which defines a representation system of a response is should be further defined. Each Method should include a parameter translation (ParamTranslation) 414 which will be included in the request and response. These are interpreted by the interpreter 214, and generated and reflected in the integration framework in accordance with the interface 314.

The actual implementations of these generated elements provide an execution code (Req_impl:Request) 419 of the Request method 416, an execution code (Resp_impl:Response) 420 of the Response method 417, and an execution code (PT_impl:ParamTranslation) 415 of the parameter translation 414 as respective functions in the actual implementation 320 by a bind interface 321 of the implementation binder 215.

For example, if a “POST/system/interpreter/WADL HTTP/1.1 . . . application/wadl . . . ” request is presented for example.wadl including a /example resource which can use a POST/GET method, the integration framework generates “/example” in the Resource 412 by utilizing the interpreter resources (/system/interpreter/WADL) 322 and 314, and generates {Request.POST, Request.GET, Response.POST, Response.GET} in the Request method 416 and the Response method 417 of this resource. Subsequently, the actual implementation code (example.so) of the {Request.POST, request.GET} is bound through the implementation binder 215.

Subsequently, when a request such as “POST /example HTTP/1.1 . . . ” is received from a certain client, the integration framework performs the implementation code of Request.POST and returns the result in accordance with Response.POST.

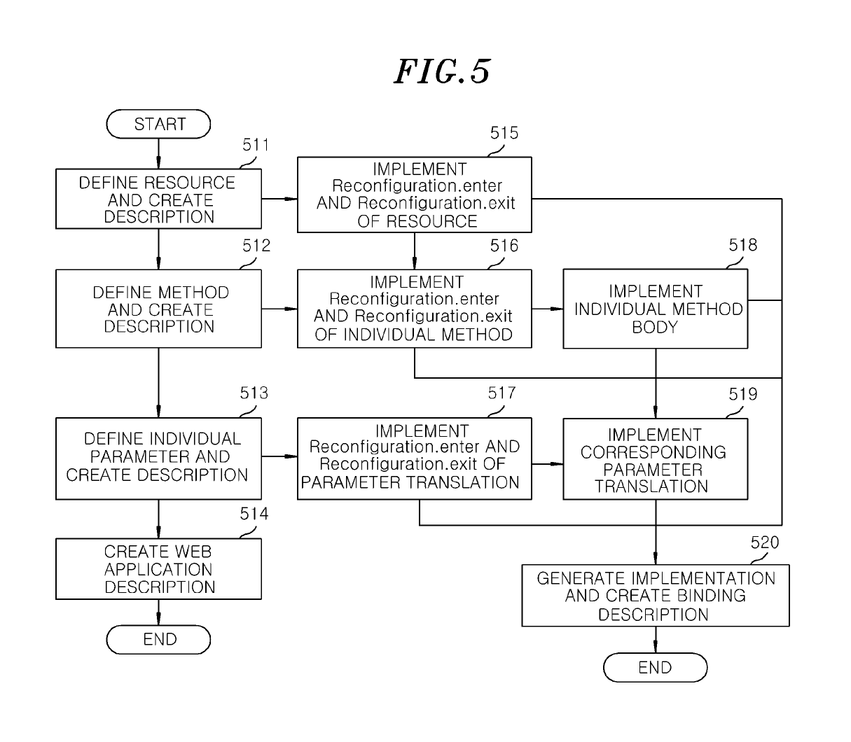

FIG. 5 is a flowchart illustrating two procedures necessary for constructing a service in an integration framework.

As illustrated in FIG. 5, in order to construct a service, the description of a REST service is required, and WADL which is a representative description language of a REST Web service or the like may be used. If an internal interpreter is provided, the description may be created through the description language which is recognized by the interpreter.

For the REST style service description, a resource should be defined, in operation 511.

Next, a CRUD based Method which is usable through the resource needs be defined and described, in operation 512.

The defined Method may add the definition of parameters necessary for processing to the Method definition, in operation 513.

Operations 511 to 513 are repeated so as to create the final Web application description (description using WADL) including a hierarchy structure between resources, in operation 514.

The created description is interpreted through the interpreter 214 in the integration framework as shown in FIG. 3, and thus a resource layer and a Method are generated in the integration framework.

Meanwhile, since a service which will be constructed in the integration framework needs to be reconfigurable, after the description of the resource is created, in operation 511, implementations which should be reflected in the system during the reconfiguration of the resource needs to be included, in operation 515.

In regard to the Method and the parameter translation, similarly, additional implementations for reconfiguration may be included, in operations 516 and 517.

Thereafter, an actual processing on an individual Method (Request, Response) is implemented, in operation 518.

After a coder to change the parameter necessary for executing the individual Method is implemented, in operation 519, a library in the form of being presented to the implementation binder is generated, and binding description is created, in operation 520.

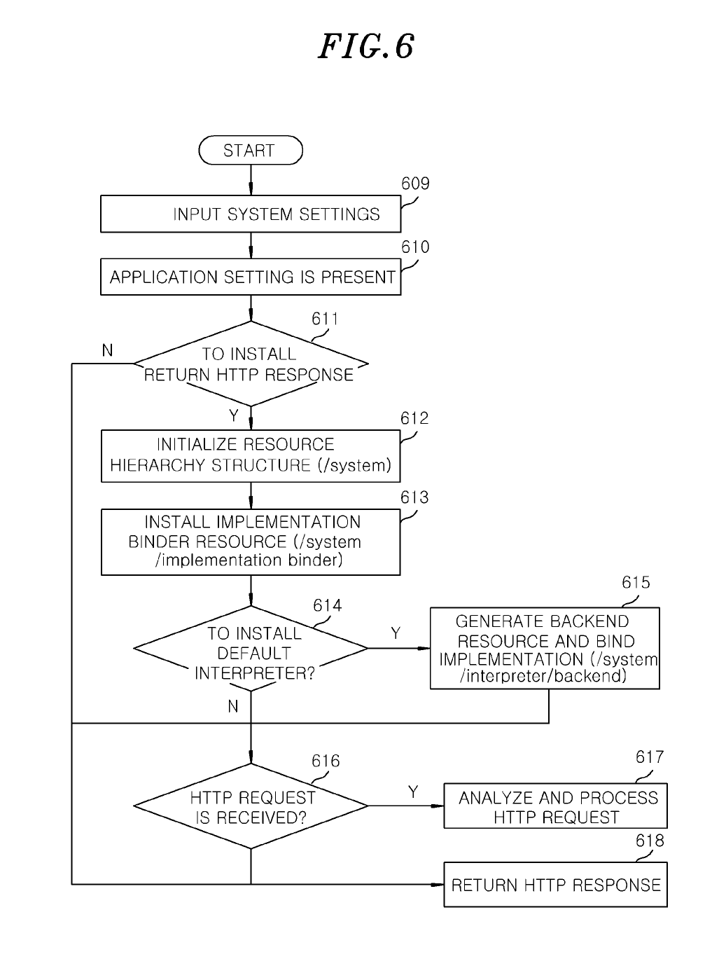

FIG. 6 illustrates an initial operation flow of a device in which the integration framework is mounted, for example, the first device 100/1.

The device can perform communication after the integration framework is activated.

When the device is powered on and the integration framework is activated, an initial system setting is read from a file system, in operation 609.

If an application setting is present, an integration application is installed, in operation 610.

Thereafter, if it is determined that the installation of an additional system resource is not required from the system settings, the operation state is immediately switched to a standby state for a request, in operation 5616.

If the installation of a system resource is required in operation 611, a system resource (/system) for mounting the system elements (for example, an interpreter and an implementation binder) of the integration framework is generated, in operation 612.

Basic resource and method of the implementation binder are installed in accordance with the system settings in operation 611, in operation 613.

Thereafter, if, in operation 614, it is determined that the addition of an interpreter is possible from the system settings, a lower-level resource (/system/interpreter/backend) of the system resource (/system), a relevant method is set, and an implementation code is bound, in operation 615.

Therefore, it stands by for the reception of an external request message, in operation 616.

The addition of an interpreter is possible in accordance with the external request message. While it stands by for the reception of the external request message, if an HTTP request is received, the integration framework analyzes the external request message and calls a processing routine, in operation 617.

If the request message is processed, a response message is returned along with the processing result, in operation 618.

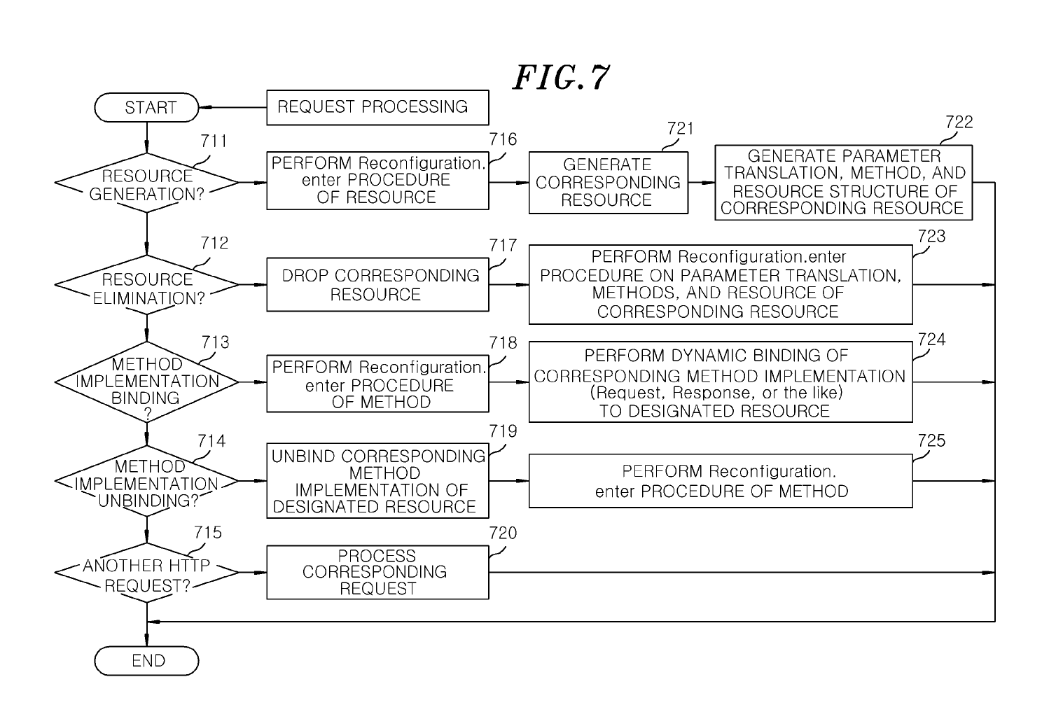

FIG. 7 is a flowchart illustrating a procedure for interpreting and processing an HTTP request including procedures at the time of generation and elimination of a resource in a system framework, and binding and unbinding of a Method.

As shown in FIG. 7, when it is determined that the HTTP request is a resource generation, in operation 711, a Reconfiguration.enter procedure which should be implemented in accordance with the Reconfiguration template 411 for setting the reconfiguration of a system/application resource necessary for reconfiguration before the generation of the corresponding resource (in operation 721) is performed.

After the procedure is performed in operation 716, the structure of the Resource 412, Methods 413, 416, and 417, and the parameter translation (ParamTranslation) 414 associated with the corresponding resource is generated.

When the HTTP request is resource elimination in operation 712, the corresponding resource and the lower-level resources on the hierarchical structure of the corresponding resource are not utilized, and a Reconfiguration.exit procedure is performed on all resources 412, Methods 413, 416, and 417, and parameter translation 414 associated with the resources.

If the HTTP request is a Method implementation binding request in operation 713, a Reconfiguration.enter procedure of the corresponding Method is performed, in operation 718, and then the corresponding implement codes is bound to a designated resource through the implementation binder, in operation 724.

If the HTTP request is a Method implementation unbinding request in operation 714, a Method (request or response) as a Method definition part of the designated resource and an implement code are unbound, in operation 719, and then a Reconfiguration.exit procedure of the corresponding method is performed.

In regard to other HTTP requests, the corresponding request is performed and the result is returned in operation 720. As a representative example, there is a GET request to get information a specific resource.

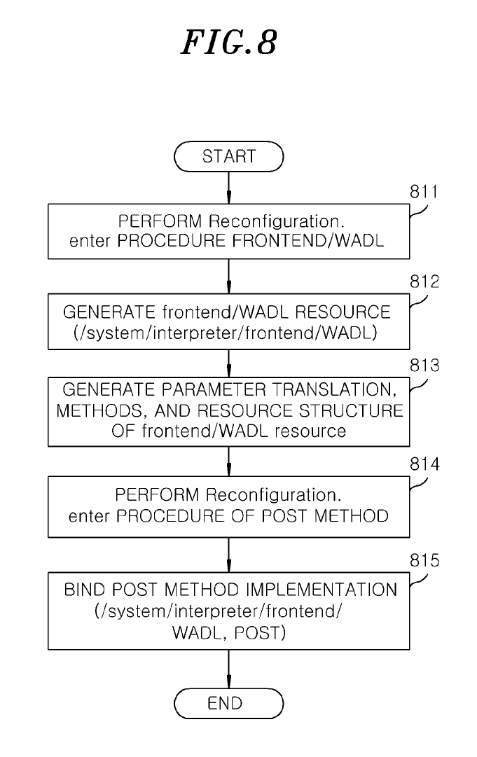

FIG. 8 is a flowchart illustrating a procedure for reconfiguration a system resource (WADL interpreter) in accordance with the flowchart of FIG. 7.

As shown in FIG. 8, when a WADL interpreter is added in the integration framework, first, a Reconfiguration.enter procedure including a necessary operation is performed taking into consideration of unbinding of a current resource in operation 811.

Next, an actual interpreter resource (/system/interpreter/frontend/WADL) is generated, in operation 812, and a structure for binding the resource to various implementations is generated, in operation 813.

A Reconfiguration.enter procedure is performed individually on a method structure (response, request, or the like) generated in association with the operation of the resource, in operation 814.

Thereafter, the individual method structure and the actual implementation code are bound, in operation 815, and the client can use the WADL interpreter in the integration framework.

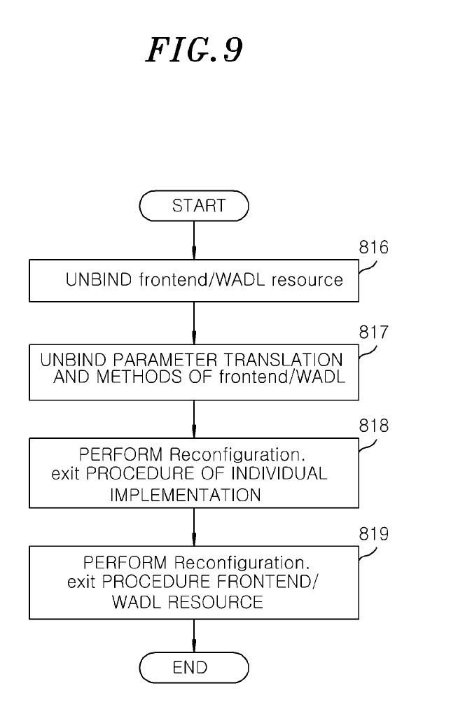

FIG. 9 is a flowchart illustrating a procedure of unbinding a resource.

First, a resource (/system/interpreter/frontend/WADL) is switched to an inactive, in operation 816, and the method structure or the like associated with the resource is unbound, in operation 817.

Thereafter, a Reconfiguration.exit procedure on the method structure and the resource is performed in order, in operations 818 and 819, thereby eliminating the WADL interpreter from the integration framework.

According to the embodiment of the present invention described above, a REST style service included in various sensor nodes, user terminals, or servers in an environment, such as Machine to Machine (M2M), Internet of Things (IoT), or Web of Things (WoT), is constructed. Accordingly, it is possible to recognize a request between services mounted in respective devices (execution of a resource and a method), to generate a resource through interpretation of Web service description in response to the request, to permit binding of a relevant method at the time of the request, and to reconfigure an unwanted resource and a relevant method in response to the request. Therefore, it is possible to construct a single REST style system which can be reconfigured and applied in accordance with the constraints of the target device.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An integration framework system comprising:
an interpreter configured to provide a general-purpose description and interpretation of a resource, a method, and a parameter regarding a hardware device on a network of things; and
an implementation binder configured to provide dynamic binding or dynamic unbinding depending on the change in the resource of the hardware devices.

2. The integration framework system of claim 1, wherein the network of things is based on a representation state transfer (REST) style.

3. The integration framework system of claim 1, wherein the implementation binder provides dynamic binding or dynamic unbinding of a resource of an application service.

4. The integration framework system of claim 1, wherein the implementation binder provides dynamic binding or dynamic unbinding of a resource of a system service.

5. The integration framework system of claim 1, wherein the integration framework system supports a dynamic reconfiguration depending on a remote control and hardware constrained performance of a system resource and an application resource.

6. A method of providing an integration framework for an integration framework system, the method comprising:
processing a description language regarding a hardware device on a network of things;
providing dynamic binding or dynamic unbinding regarding implementation while a system is operating; and
providing a resource, a method, and representation for dynamic reconfiguration of the hardware device.

7. The method of claim 6, wherein said processing a description language comprises:
defining a resource;
defining a usable method through the resource; and
adding definition regarding a parameter to the method.

8. The method of claim 6, wherein the network of things is based on a REST style.

9. The method of claim 6, wherein said providing dynamic binding or dynamic unbinding comprises:
providing dynamic binding or dynamic unbinding of a resource regarding an application service.

10. The method of claim 6, wherein said providing dynamic binding or dynamic unbinding comprises:
providing dynamic binding or dynamic unbinding of a resource regarding a system service.

11. The method of claim 6, wherein said providing dynamic binding or dynamic unbinding comprising:
supporting a dynamic reconfiguration depending on a remote control and hardware constrained performance of a system resource and an application resource.
